(19) United States
(12) Patent Application Publication
(10) Pub. No.: US 2004/0095829 A1
(43) Pub. Date: May 20, 2004

(54) Ruggedised solid-state storage device

(76) Inventors: David Barnbrook, Hassocks (GB); Stephen John Chapman, Littlehampton (GB)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/341,825

(22) Filed: Jan. 14, 2003

(30) Foreign Application Priority Data
Nov. 19, 2002 (GB) 0226982.7

(51) Int. Cl. G11C 7/00

(52) U.S. Cl. 365/222

(57) ABSTRACT

A portable information storage device 10 comprises a solid-state electronic memory (not shown), and a tubular enclosure 12 for the memory, the device having a neck 14 on which is mounted a connector 16 (e.g. a 62 GB military connector) for serial data communication with the memory, the enclosure having an access opening 18 closed by a closure member 20.

This invention relates to removable, solid state, electronic information storage devices for use with computers, data logging devices and the like. Known devices of this kind include so-called USB keys, which comprise a non-volatile, solid-state memory module configured to interface with a host computer or other data processing device via a standard USB connector. Information such as programs or data may be uploaded from the host to the key, or downloaded from the key to the host, using standard drivers and operating systems, e.g. Windows (RTM). The key may therefore be used for data backup or, if the data is uploaded from one host and then downloaded to a different host, for data transfer.

When data communication is not in progress over the USB connector, the key may be detached from the host device for offsite storage or for movement between hosts. The USB key is compact, portable and has a relatively large memory capacity. Commercially available storage devices of this type are designed for use in “clean,” controlled environments. However, many backup or data transfer operations take place in the field where exposure to water, dirt and other contaminants, as well as extremes of temperature, electromagnetic interference, applied loads, shock and vibration could damage the storage device or corrupt the data held on it. There is thus a need for a solid-state information storage device that is readily portable, but which will withstand rough handling and harsh environments.

Accordingly, the present invention provides a portable information storage device comprising a solid-state electronic memory, and a tubular enclosure for the memory, the device having a neck on which is mounted a connector for serial data communication with the memory, the enclosure having an access opening closed by a closure member. The tubular enclosure and closure member together preferably thereby form a strong, hermetically sealed enclosure for the memory. In this way, the device will form a simple, robust protective housing for the electronic memory. The connector may comprise connecting leads which, with the connector in place on the enclosure, can extend through the access opening for connection to the electronic memory externally of the device. Once the leads have been connected (e.g. by soldering to a circuit board carrying the electronic memory), the electronic memory and connecting leads can be pushed into the enclosure and the closure member secured in/over the access opening.

The enclosure preferably provides or incorporates EMC shielding. For this purpose it may be formed from a conductive material, such as a metal, preferably aluminium alloy. Besides providing the necessary EMC shielding, aluminium is also strong, light and readily machined or die-cast to shape. Alternatively, the enclosure may be moulded from plastics, with a suitable conductive filler, or with a metallic screening layer applied or adjacent to its internal or external surfaces, or with such a screening layer incorporated in the walls of the enclosure.

The connector may be a standard military specification e.g. 62 GB connector, or any equivalent connector providing the necessary robustness and EMC shielding. Preferably the connector has a screw-threaded collar for application to the neck. It may incorporate locking formations to prevent it from being unscrewed once applied. The threaded connection between the neck and connector may additionally or alternatively be locked and/or sealed by a suitable settable liquid, such as Locktite (RTM). A separate sealing element such as an O-ring may additionally or alternatively be used between the connector and neck.

The closure member may likewise be threadingly connected within or across the access opening, with similar locking/sealing means as used for the connector. In a preferred form, the closure member and enclosure therefore have circular cross-sections, with the access opening being formed in an end of the tubular enclosure, opposite to the neck.

With the connector applied and the memory connected and installed in the enclosure, but prior to installation of the closure member, the remaining space in the enclosure can be filed with a suitable potting compound. This may be of a type that solidifies, or alternatively may be a gel or resilient foam, for additional shock and vibration protection. Still alternatively, pre-formed resilient (e.g. foam) packing pieces or other anti-vibration mountings can be used to support and mechanically isolate the memory within the enclosure.

A decorative and/or protective surface treatment may be applied to the exterior of the enclosure. For example, where the enclosure is formed from aluminium alloy, it may be anodised. Alternatively, a heat-shrinkable polymer wrapper may be used, or a compatible paint or plated surface layer.

The invention and its preferred features and advantages are further described below, with reference to illustrative embodiments shown in the drawings, in which:

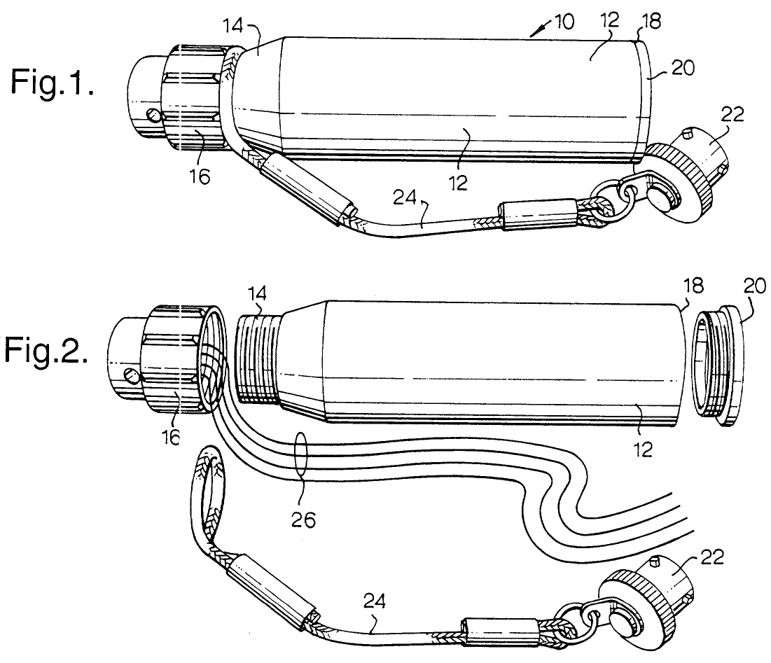

FIG. 1 shows a first USB key embodying the invention;

FIG. 2 shows parts of the key of FIG. 1 disassembled, and

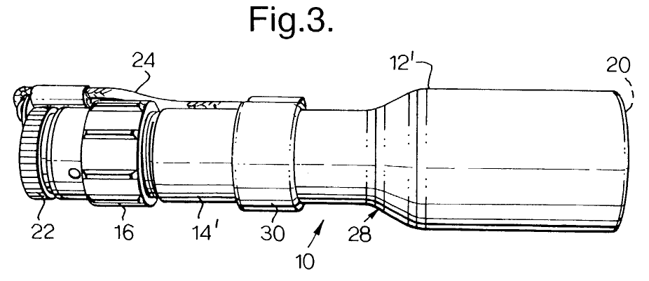

FIG. 3 shows a second USB key embodying the invention.

The USB key 10 shown in FIGS. 1 and 2 comprises a tubular enclosure 12 machined from aluminium alloy. The enclosure 12 has a threaded neck 14 onto which a standard 62 GB military connector 16 is screwed. The neck 14 forms a simple and convenient mounting for the threaded collar of the connector 16. The threaded connection thus formed may be locked and sealed by Locktite (RTM), as well as by the anti-backoff formations on the connector 16 and O-ring seals or the like. The opposite end 18 of the enclosure 12 is formed as an internally threaded access opening into which an externally threaded closure member or plug 20 is screwed. The plug 20 may likewise be sealed and secured to the enclosure 12 by Locktite (RTM) and/or an O-ring or the like. A dust cap 22 for the connector 16 may be attached to the enclosure 12 by a retaining strap 24. As shown in FIG. 2, the electrical leads 26 from the connector 16 are long enough to pass through the entire length of the enclosure 12 with the connector 16 in place on the neck 14. The leads 26 can thus protrude from the access opening 18 for attachment to the memory circuit board (not shown). The circuit board can then be pushed into the access opening 18, suitable potting compound/gel/foam/resilient packing or shock and vibration isolators applied between the circuit board and the interior walls of the enclosure 12, and the plug 20 screwed in the opening 18 and secured/sealed in place.

The USB key shown in FIG. 2 is of generally similar construction, except that the enclosure has a longer neck portion 14′ and a widened body portion 12′ for accommodating the memory circuit board. A heat shrinkable polymer wrapper 28 covers the neck and body portions. A band 30 of the same material is used to anchor the retaining strap 24 to the enclosure.

Although a USB interface has been described above, any suitable serial interface will suffice for communication with the memory, provided that the number of individual electrical contacts (including all necessary power and data channels) is low enough to be accommodated in a ruggedised connector, preferably a readily available military specification connector such as 62 GB. For example, an IEEE 1394 (“firewire”) interface could also be used. The mechanical connection between the connector 16 and a complementary connector on the host device (not shown) need only be made up whilst data communication is taking place. Ordinarily therefore, this mechanical connection need not meet any severe drop tests. However, if required, the neck could incorporate an elbow, so that when connected, the longitudinal axis of the key enclosure 12 lies generally parallel to the adjacent wall of the host device. This wall can additionally or alternatively be provided with a recess, bracket or clip in which the enclosure 12 is mechanically supported.

Although the connector 16 is shown attached to the neck 14 of the enclosure 12 by a threaded connection, other mounting methods such as crimping can be used. Although the tubular enclosure 12 is illustrated as having a circular cross-section, which is easy to machine and compatible with a threaded connector 16 and plug 20, other cross-sectional shapes, such as square or rectangular, can be used where appropriate. Furthermore, although the access opening 18 is shown as being opposite to the neck 14, it may be formed at any convenient location on the enclosure 12. For example, the circular junction between the access opening 18 and the plug 20 shown in the drawings may be located closer to the neck 14, so that part of the enclosure 12 interior is in the plug 20. In fact, either part of the enclosure to one side of the junction line may be regarded as the plug, and the other part as the tubular enclosure. When the access opening is positioned closer to the neck 14, shorter connecting leads 26 on the connector 16 can be used.

1. A portable information storage device comprising a solid-state electronic memory, and a tubular enclosure for the memory, the device having a neck on which is mounted a connector for serial data communication with the memory, the enclosure having an access opening closed by a closure member.

2. A device as defined in claim 1, comprising connecting leads which, with the connector in place on the enclosure, can extend through the access opening for connection to the electronic memory externally of the device.

3. A device as defined in claim 1, in which the enclosure provides or incorporates EMC shielding.

4. A device as defined in claim 1, in which the enclosure is formed from a conductive material.

5. A device as defined in claim 1, in which the enclosure is formed from a metal.

6. A device as defined in claim 1, in which the enclosure is formed from aluminium alloy.

7. A device as defined in claim 1, in which the enclosure is formed from plastics with a conductive filler.

8. A device as defined in claim 1, in which the enclosure is formed with a metallic screening layer applied or adjacent to its internal or external surfaces, or with such a screening layer incorporated in the walls of the enclosure.

9. A device as defined in claim 1, in which the connector is of a standard military specification.

10. A device as defined in claim 1, in which the connector is a 62 GB connector.

11. A device as defined in claim 1, in which the connector has a screw-threaded collar for application to the neck.

12. A device as defined in claim 11, in which the connector incorporates locking formations to prevent it from being unscrewed once applied.

13. A device as defined in claim 11, in which the threaded connection between the neck and connector is locked and/or sealed by a settable liquid.

14. A device as defined in claim 11, in which a separate sealing element is used between the connector and neck.

15. A device as defined in claim 1, in which the closure member is threadingly connected within/over the access opening.

16. A device as defined in claim 15, in which the threaded connection between the closure member and access opening is locked and/or sealed by a settable liquid.

17. A device as defined in claim 15, in which a separate sealing element is used between the closure member and access opening.

18. A device as defined in claim 1, in which the closure member has a circular cross-section.

19. A device as defined in claim 1, in which the tubular enclosure has a circular cross-section.

20. A device as defined in claim 1, in which the access opening is formed in an end of the tubular enclosure, opposite to the neck.

21. A device as defined in claim 1, in which remaining space in the enclosure is filed with a potting compound.

22. A device as defined in claim 1, in which remaining space in the enclosure is filed with a gel.

23. A device as defined in claim 1, in which remaining space in the enclosure is filed with resilient foam.

24. A device as defined in claim 1, in which resilient packing pieces or other anti-vibration mountings are used to support and mechanically isolate the memory within the enclosure.

25. A device as defined in claim 1, in which a decorative and/or protective surface treatment is applied to the exterior of the enclosure.
